(19) United States
(12) Patent Application Publication
(10) Pub. No.: US 2015/0016659 A1
(43) Pub. Date: Jan. 15, 2015

(54) MINIATURE ELECTROACOUSTIC TRANSDUCER AND ASSEMBLING METHOD THEREOF

(71) Applicants: Ze Wang, Shandong (CN); Lianshan Ge, Shandong (CN); Chunfa Liu, Shandong (CN)

(72) Inventors: Ze Wang, Shandong (CN); Lianshan Ge, Shandong (CN); Chunfa Liu, Shandong (CN)

(73) Assignee: GOERTEK INC. a corporation

(21) Appl. No.: 14/379,835

(22) PCT Filed: Feb. 22, 2012
(86) PCT No.: PCT/CN2012/071461

§ 371 Date: Sep. 4, 2014

(30) Foreign Application Priority Data
Feb. 20, 2012 (CN) 201210037945.1

(51) Int. Cl. H04R 9/02; H04R 31/00; H04R 9/04

(52) U.S. Cl. CPC H04R 9/025; H04R 9/046; H04R 31/00; H04R 2209/022; H04R 2209/024
USPC 381/412; 29/594

(57) ABSTRACT

A miniature electroacoustic transducer includes: a metal shell, having the shape of a barrel with one open end; a vibrating system, including a vibrating diaphragm and a voice coil; and a magnetic circuit system, including a concentrating flux plate, a magnet and a magnetic yoke that are sequentially combined together. The magnetic circuit system is formed with a magnetic gap corresponding to the voice coil; the vibrating system and the magnetic circuit system are fixedly installed in the barrel-shaped shell; the components in the structure are further modularized, maximizing the magnet under the same product dimension and effectively improving the product sensitivity. An assembling method of the electroacoustic transducer includes: a. providing a barrel-shaped metal shell with one open end; b. putting a pre-assembled vibrating system into the shell; c. putting a pre-assembled magnetic circuit system into the shell; and d. fixedly assembling the shell with the magnetic yoke.

### TECHNICAL FIELD

The present invention relates to the electroacoustic field, particularly to a miniature electroacoustic transducer and an assembling method of the same.

### BACKGROUND ART

With the rapid development of portable electronic products such as cellphone and laptop, a large number of electroacoustic transducers particularly miniature electroacoustic transducers are widely used. The conventional miniature electroacoustic transducer comprises a vibrating system, a magnetic circuit system and a shell for fixing the vibrating system and the magnetic circuit system, and a front cover is arranged on the shell, wherein the shell is typically a plastic shell, the magnetic circuit system is fixed by adhesive or injection molding, and the vibrating system is fixed by a series of tooling fixtures.

In this type of conventional electroacoustic transducer, its components and parts are relatively separate from each other which causes the design of the product complicated, and meanwhile the size of the magnet is in constraints due to the injection-molded shell which may have adverse effects to the improvements of sensitivity; and further, a lot of tooling fixtures and complicated assembling process are required in the assembling of the product, which is not good to cost-efficiency.

Thus, there is a need for further improving the structure and assembling procedures of the conventional miniature electroacoustic transducer to avoid the above defects.

### SUMMARY OF THE INVENTION

### Technical Problem

The technical problem sought to be solved by the present invention is to provide a miniature electroacoustic transducer which is capable of further modularizing internal components of the miniature electroacoustic transducer, simplifying product design, maximizing the size of the magnet under the same product dimension and effectively improving the product sensitivity; meanwhile, to provide an assembling method of the miniature electroacoustic transducer, by which the modularized components can be assembled in a modularized way, thereby simplifying the product assembling process and reducing the production cost.

### Technical Solution

In order to achieve the above objectives, the miniature electroacoustic transducer provided by the present invention comprises: a metal shell, having the shape of a barrel with one open end; a vibrating system, comprising a vibrating diaphragm and a voice coil; and a magnetic circuit system, comprising a concentrating flux plate, a magnet and a magnetic yoke that are sequentially combined together, wherein the magnetic circuit system is formed with a magnetic gap corresponding to the voice coil, and the vibrating system and the magnetic circuit system are fixedly installed in the barrel-shaped shell.

As an improvement, an opening for sound output is arranged at the bottom of the shell.

As an improvement, a first support is arranged between the vibrating system and the bottom of the shell.

As an improvement, a second support is arranged between the vibrating system and the magnetic circuit system.

As an improvement, a positioning step for fixing the magnetic circuit system correspondingly is arranged on the second support.

As an improvement, a transition trench is arranged at the bottom of the shell proximate to the sidewall.

As an improvement, the shell and the concentrating flux plate are fixed by the seaming of the sidewall of the shell.

As an improvement, the vibrating system further comprises a centering pad through which the voice coil is electrically connected with an external circuit of the miniature electroacoustic transducer.

The assembling method of the miniature electroacoustic transducer provided by the invention comprises the following steps:

(a) providing the barrel-shaped metal shell with one open end;

(b) placing a pre-assembled vibrating system into the shell to position the vibrating system corresponding to the opening for sound output of the shell;

(c) placing a pre-assembled magnetic circuit system into the shell;

(d) fixedly assembling the shell with the magnetic yoke.

As an improvement, a first support is arranged between the vibrating system and the bottom of the shell; and the vibrating system is assembled with the first support integrally together before the step (b).

As an improvement, the vibrating diaphragm comprises a spherical top portion in the center and a loop-bending portion on the edge, a centering pad is arranged between the vibrating diaphragm and the voice coil, and the assembling of the vibrating system comprises the following steps:

(a) assembling the spherical top portion with the centering pad, and assembling the loop-bending portion with the first support;

(b) assembling the spherical top portion which is assembled with the centering pad with the loop-bending portion which is assembled with the first support together.

As an improvement, a second support is arranged between the vibrating system and the magnetic circuit system; and the magnetic circuit system is assembled with the second support integrally together before the step (c).

As an improvement, the magnetic circuit system is of dual magnetic circuit structure comprising an external concentrating flux plate and an external magnet, and an internal concentrating flux plate and an internal magnet which are sequentially assembled with the magnetic yoke respectively; and the magnetic circuit system is assembled by the following steps:

(a) assembling the internal concentrating flux plate, the internal magnet and the magnetic yoke sequentially, and fixedly assembling the external concentrating flux plate with the second support;

(b) assembling the external concentrating flux plate and the second support which have been assembled together, and the external magnet, with the internal concentrating flux plate, the internal magnet and the magnetic yoke, which have been assembled together, sequentially.

### ADVANTAGEOUS EFFECTS OF THE INVENTION

With the above technical solution, compared with conventional structures, the components in the structure of the miniature electroacoustic transducer provided by the invention are further modularized, thereby simplifying the product design, maximizing the size of the magnet under the same product dimension and effectively improving the product sensitivity. Meanwhile, with the assembling method of the miniature electroacoustic transducer provided by the present invention, the modularized components can be assembled in a modularized way, thereby simplifying the product assembling process and reducing the production cost.

### BRIEF DESCRIPTION OF THE DRAWINGS

The present invention is described in connection with the accompanying drawings and embodiments.

FIG. 1 is an exploded schematic view illustrating the miniature electroacoustic transducer according to the embodiments of the present invention;

FIG. 2 is a schematic cross-section view illustrating the miniature electroacoustic transducer according to the embodiments of the present invention;

FIG. 3 is a perspective view illustrating the shell of the miniature electroacoustic transducer according to the embodiments of the present invention;

FIG. 4 is a schematic cross-section view illustrating the shell of the miniature electroacoustic transducer according to the embodiments of the present invention;

FIG. 5 is a schematic partial enlarged view of the part A in FIG. 4;

FIG. 6 is a schematic assembly view illustrating the spherical top portion and the centering pad of the miniature electroacoustic transducer according to the embodiments of the present invention;

FIG. 7 is a schematic view illustrating the spherical top portion and the centering pad in FIG. 6 after being assembled;

FIG. 8 is a schematic assembly view illustrating the loop-bending portion and the first support of the miniature electroacoustic transducer according to the embodiments of the present invention;

FIG. 9 is a schematic view illustrating the loop-bending portion and the first support in FIG. 8 after being assembled;

FIG. 10 is a schematic assembly view illustrating the internal concentrating flux plate, the internal magnet and the magnetic yoke according to the embodiments of the present invention;

FIG. 11 is a schematic view illustrating the internal concentrating flux plate, the internal magnet and the magnetic yoke in FIG. 10 after being assembled;

FIG. 12 is a schematic assembly view illustrating the external concentrating flux plate and the second support of the miniature electroacoustic transducer according to the embodiments of the present invention;

FIG. 13 is a schematic assembly view illustrating the structures in FIG. 10 and FIG. 12 assembled with the external magnet;

FIG. 14 is a schematic view illustrating the structures in FIG. 13 after being assembled;

FIG. 15 is a schematic assembly view illustrating the miniature electroacoustic transducer according to the embodiments of the present invention; and

FIG. 16 is a schematic view illustrating the structures in FIG. 15 after being assembled.

### DETAILED DESCRIPTION OF THE EMBODIMENTS

In the below, the present invention is described in detail in connection with the accompanying drawings.

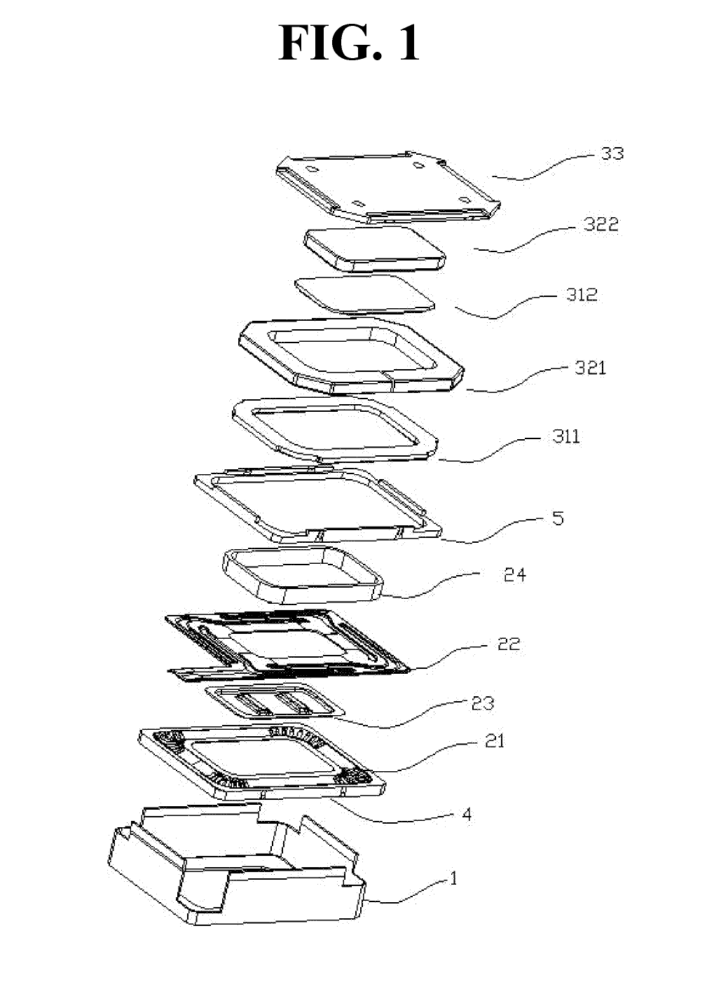

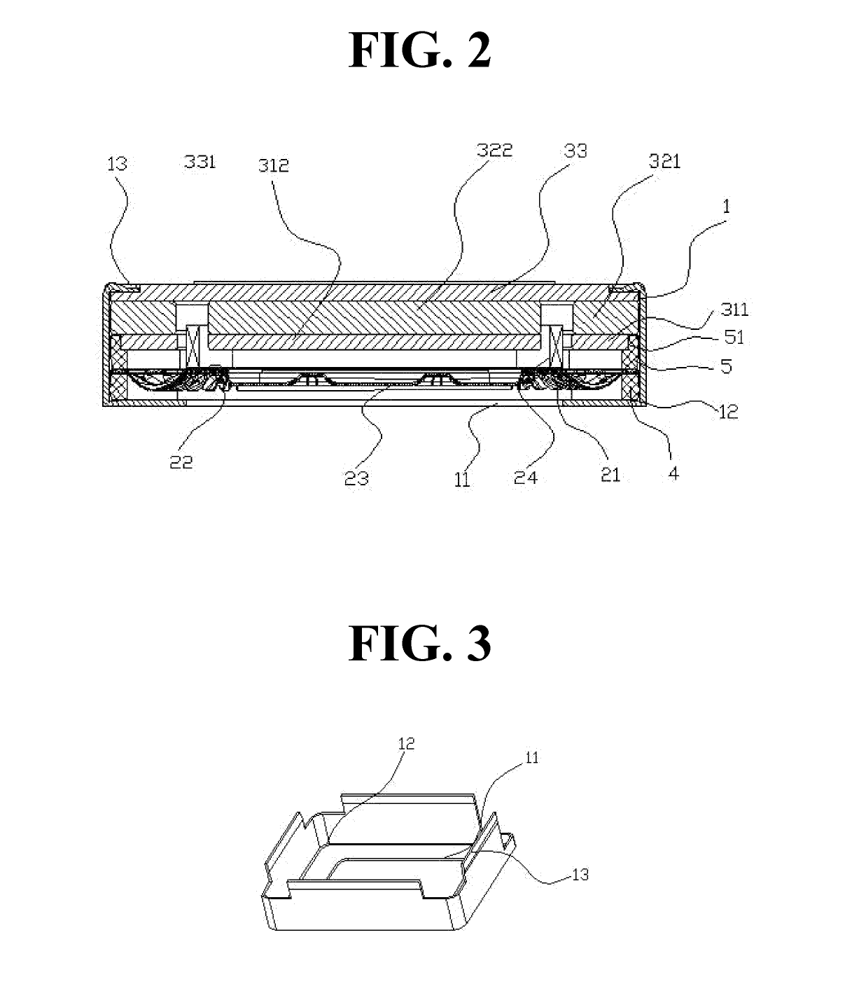

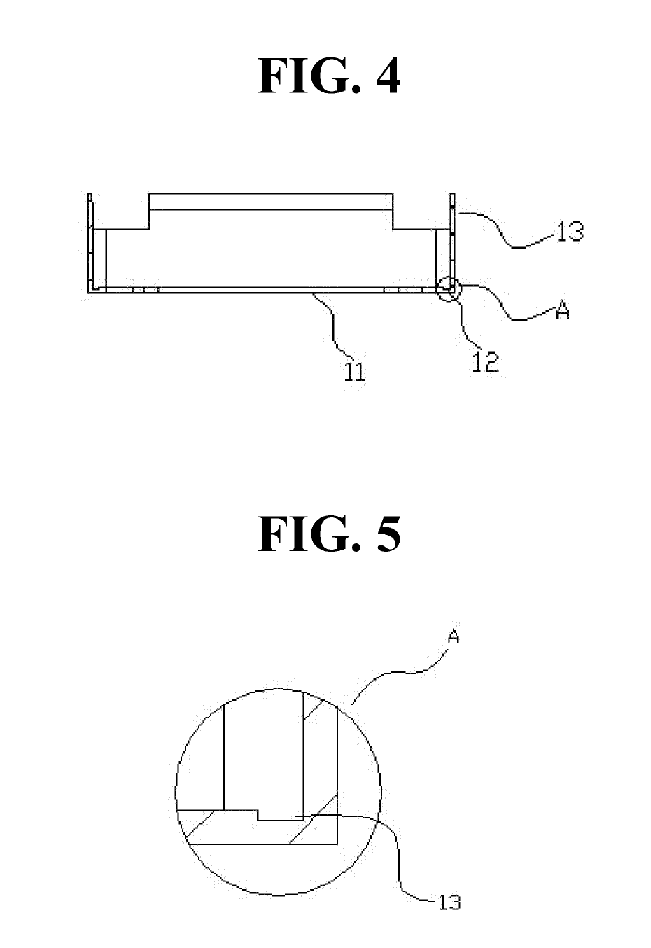

As illustrated in FIGS. 1 to 5, a miniature electroacoustic transducer comprises: a barrel-shaped metal shell 1; a vibrating system, comprising a vibrating diaphragm and a voice coil 24; and a magnetic circuit system forming a magnetic gap corresponding to the voice coil 24, the magnetic circuit system acting on the voice coil 24 to enable the vibrating system to vibrate and sound when the voice coil 24 is applied with an alternating current signal, the magnetic circuit system comprising a concentrating flux plate, a magnet and a magnetic yoke 33 that are sequentially combined together; and the vibrating system and the magnetic circuit system are fixedly installed in the barrel-shaped shell 1.

With such a design where the external assembly structure of the miniature electroacoustic transducer is formed by the barrel-shaped shell, and the vibrating system and the magnetic circuit system are installed in the shell, the components in the structure of the miniature electroacoustic transducer provided by the invention are further modularized, thereby simplifying the product design while the overall thickness of the shell can be reduced with the structure of the metal shell, thus maximizing the size of the magnet under the same product dimension and effectively improving the product sensitivity.

In the present embodiment, the metal shell 1 is fixedly assembled with the magnetic yoke 33 so as to fixedly house the miniature electroacoustic transducer. In the present embodiment, the magnetic circuit system is preferably of a dual magnetic circuit structure comprising an internal concentrating flux plate 312 and an internal magnet 322, and an external concentrating flux plate 311 and an external magnet 321 which are sequentially assembled with the magnetic yoke 33 respectively. The dual magnetic circuit system can provide greater driving force. And the magnetic circuit structure of the magnet may also be only one magnet of an internal or external magnetic circuit structure based on actual demand.

In the present embodiment, in order to achieve better acoustics, preferably, an opening 11 for sound output is arranged at the bottom of the metal shell 1, the vibration system is provided so as to correspond to the opening 11; the shell 1 and the magnetic yoke 33 are fixedly assembled together by laser weld, glue bonding or seaming, and the shell 1 in the present embodiment is fixedly assembled with the magnetic yoke 33 by seaming of the side wall, which is a simpler way of assembly; vibrating space can be provided for the diaphragm between the vibrating system and the bottom of the shell 1 by providing independent supports or making parts of the shell 1 protruding outward based on the characteristics of different product structures, it is preferable to provide a first support 4 between the vibrating system and the shell 1 by which first support 4 the vibrating system and the bottom of the shell 1 are spaced apart from each other so as to provide enough vibrating space for the diaphragm; additionally, a second support 5 is preferably arranged between the magnetic circuit system and the vibrating system, which enables precise location of the vibrating system and the magnetic circuit system; with the provision of the independent supports, product design can be simplified, and the assembling process is simple; the first support 4 and the second support 5 can be insulating material such as plastic material, in order to improve the assembly strength of the miniature electroacoustic transducer according to the embodiments of the present invention, a positioning step 51 corresponding to the assembly of the magnetic circuit system is further arranged on the second support 5, which makes the overall structure firmer.

Additionally, a transition trench 12 is arranged in the region proximate to the sidewall of the shell 1 at the bottom of the shell 1, to avoid the formation of approximate fillet at the corner region between the sidewall and the bottom of the shell 1 when bending, which may affect the overall assembly height of the miniature electroacoustic transducer.

The voice coil 24 and the miniature electroacoustic transducer may be electrically connected to external circuits of the miniature electroacoustic transducer by flying leads or built-in conductive elements. In the present embodiment, a centering pad 22 is arranged between the diaphragm and the voice coil 24, the centering pad 22 may be a flexible circuit board or a conducting sheet, and the voice coil 24 is electrically connected to the outside of the miniature electroacoustic transducer through the centering pad 22. With such an improvement, it is convenient for stabilizing the electrical connection of the voice coil 24, and the miniature electroacoustic transducer is prevented from eccentric vibrating by the addition of the centering pad 22.

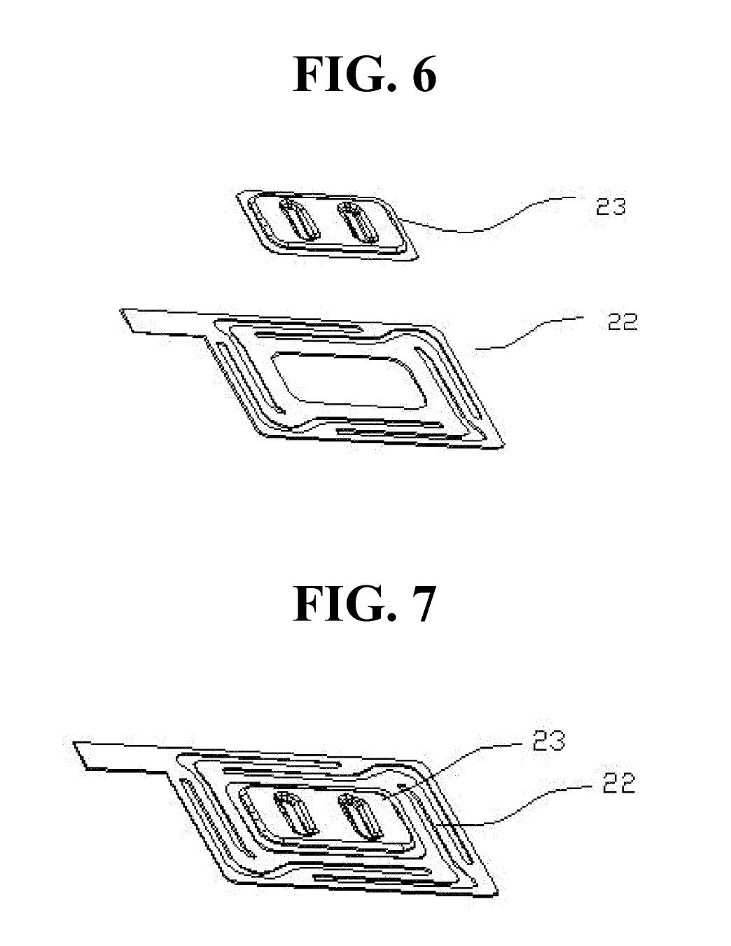

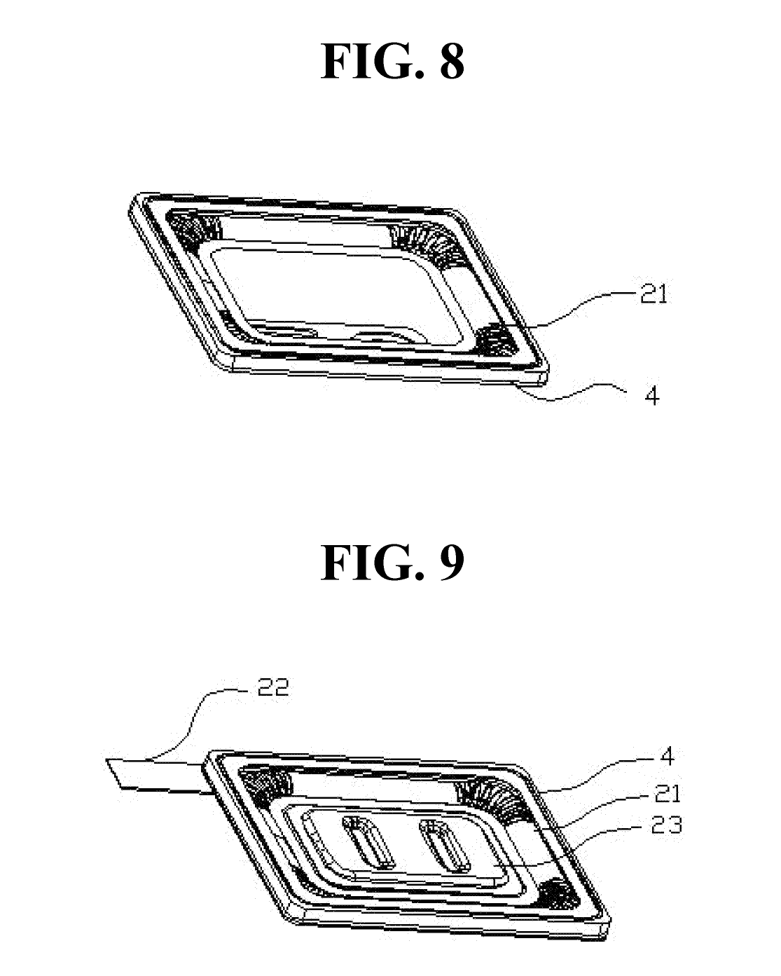

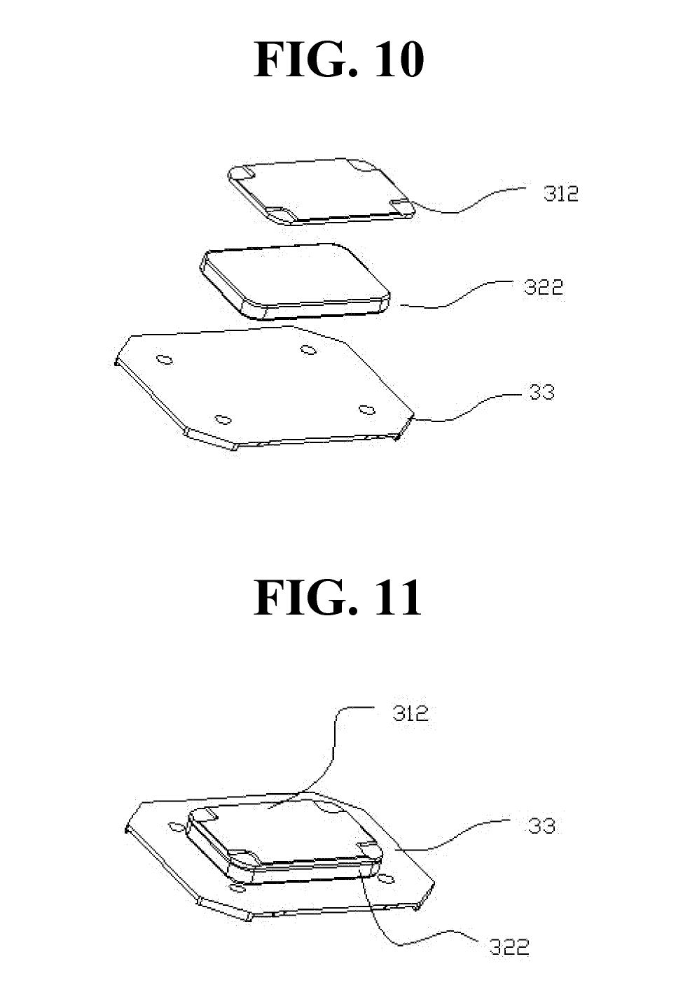

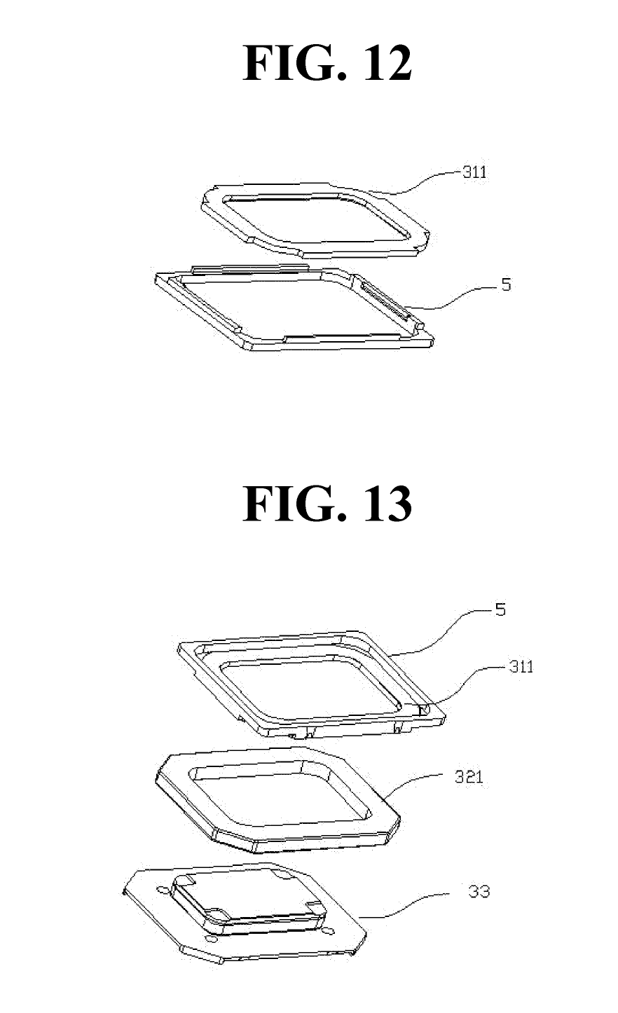

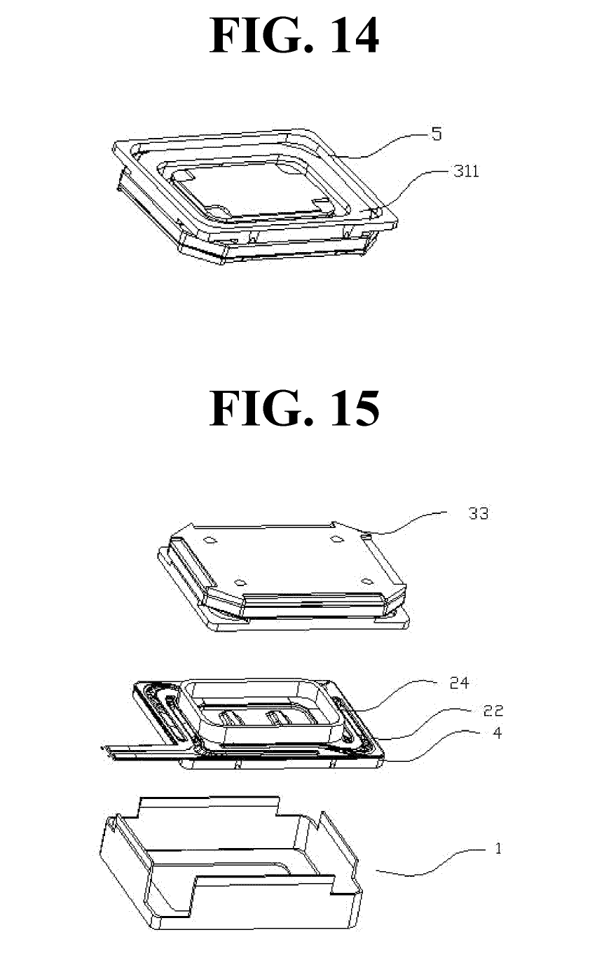

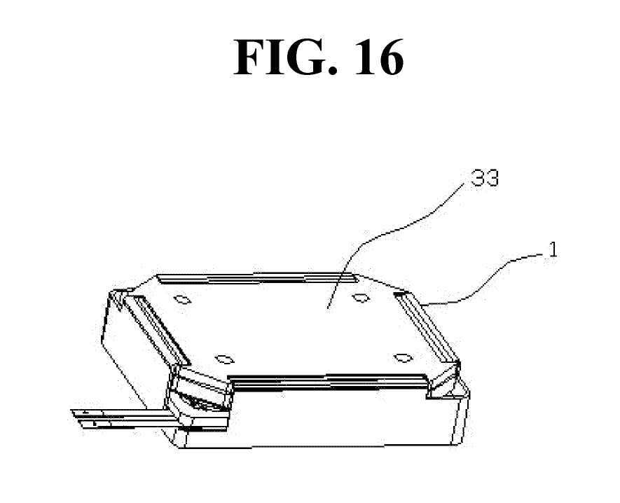

FIG. 6 to FIG. 16 are detailed description of the assembly diagram of the product according to the present embodiment. The overall structure of the miniature electroacoustic transducer in the present innovation can be assembled through the following assembling method of:

(a) providing a barrel-shaped metal shell 1 with one open end;

(b) placing a pre-assembled vibrating system into the shell 1;

(c) placing a pre-assembled magnetic circuit system into the shell 1; and

(d) fixedly assembling the shell 1 with the magnetic yoke 33.

With the assembling method of the miniature electroacoustic transducer, the vibrating system and the magnetic circuit system can be pre-assembled separately. When the overall structure of the miniature electroacoustic transducer is being assembled, the components of the miniature electroacoustic transducer are assembled in a modularized way, thereby simplifying the product assembling process and reducing the production cost.

In the assembling process for the vibrating system, it is preferable to pre-assemble the magnetic circuit system and the first support 4 integrally before the step (b), which may further facilitate modularized assembly of the product; more specifically, using the following assembling method of: (a) assembling a spherical top portion 23 with the centering pad 22, and a loop-bending portion 21 with the first support 4; (b) assembling the spherical top portion 23 assembled with the centering pad 22 with the loop-bending portion 21 assembled with the first support 4 together. With such a design improvement, the first support 4 may have the function of fixing the loop-bending portion 21. Meanwhile, the assembling method is simpler, and the assembly of the vibration system is simplified. While the assembling sequence for the voice coil 24 in the vibration system can be adjusted based on actual demands, it is preferable to pre-assemble the spherical top portion 23 with the centering pad 22 in the present embodiment.

In the assembling process for the magnetic circuit system, it is preferable to pre-assemble the magnetic circuit system with the second support 5 together before the step (c). By pre-assembling the magnetic circuit system with the second support 5, the components of the miniature electroacoustic transducer are further assembled in a modularized way, thereby simplifying the assembling process. More specifically, the improved magnetic circuit system is assembled as follows: (a) assembling the internal concentrating flux plate 312, the internal magnet 322 and the magnetic yoke 33 sequentially, and fixedly assembling the external concentrating flux plate 311 with the second support 5; (b) assembling the external concentrating flux plate 311 and the second support 5 which have been assembled together, and the external magnet 321, with the internal concentrating flux plate 312, the internal magnet 322 and the magnetic yoke 33 which have been assembled together, sequentially. With the assembling method for the magnetic circuit system, the assembly of the magnetic circuit system is further simplified, and the production cost is reduced.

Additionally, while the miniature electroacoustic transducer in accordance with the embodiments of the present invention has a square shape, it can also be of circular shape, track-like shape or other appropriate shape. In the present embodiment, electrical connection with the centering pad may also be replaced by incorporating a circuit board on the magnetic yoke, and the shell may also be assembled with the seaming of the circuit board. The dual magnetic circuit structure of the magnetic circuit system is only one preferable solution of the invention, and the magnetic circuit system may also be of an internal or external magnetic circuit system with a magnet located inside or outside the voice coil. Various modifications and variations, which fall into the scope of the present invention, can be made by those skilled in the art based on the above embodiments under the above teachings of the present invention. It is understood by those skilled in the art that the above specific description are just provided for better understanding of the present invention, and the scope of the present invention is defined by the claims and their equivalents.

1. A miniature electroacoustic transducer, comprising:
a metal shell, having the shape of a barrel with one open end;
a vibrating system, comprising a vibrating diaphragm and a voice coil; and
a magnetic circuit system, comprising a concentrating flux plate, a magnet and a magnetic yoke that are sequentially combined together, the magnetic circuit system is formed with a magnetic gap corresponding to the voice coil, and
the vibrating system and the magnetic circuit system are fixedly installed in the barrel-shaped shell.

2. The miniature electroacoustic transducer according to claim 1, characterized in that,
an opening for sound output is arranged at the bottom of the shell.

3. The miniature electroacoustic transducer according to claim 1, characterized in that,
a first support is arranged between the vibrating system and the bottom of the shell.

4. The miniature electroacoustic transducer according to claim 1, characterized in that,
a second support is arranged between the vibrating system and the magnetic circuit system.

5. The miniature electroacoustic transducer according to claim 4, characterized in that,
a positioning step for fixing the magnetic circuit system correspondingly is arranged on the second support.

6. The miniature electroacoustic transducer according to claim 1, characterized in that,
a transition trench is arranged at the bottom of the shell proximate to the sidewall of the shell.

7. The miniature electroacoustic transducer according to claim 1, characterized in that,
the shell and the concentrating flux plate are fixedly combined together by the seaming of the sidewall of the shell.

8. The miniature electroacoustic transducer according to claim 1, characterized in that,
the vibrating system further comprises a centering pad through which the voice coil is electrically connected with an external circuit of the miniature electroacoustic transducer.

9. An assembling method of the miniature electroacoustic transducer according to claim 1, characterized in that the assembling method comprises:
(a) providing the barrel-shaped metal shell with one open end;
(b) placing a pre-assembled vibrating system into the shell;
(c) placing a magnetic circuit system into the shell; and
(d) fixedly assembling the shell with the magnetic yoke.

10. The assembling method of the miniature electroacoustic transducer according to claim 9, characterized in that,
a first support is arranged between the vibrating system and the bottom of the shell; and the vibrating system is assembled with the first support integrally before the step (b).

11. The assembling method of the miniature electroacoustic transducer according to claim 10, characterized in that,
the vibrating diaphragm comprises a spherical top portion in the center and a loop-bending portion on the edge, a centering pad is arranged between the vibrating diaphragm and the voice coil, and the assembling of the vibrating system comprises the following steps:
(a) assembling the spherical top portion with the centering pad, and assembling the loop-bending portion with the first support;
(b) assembling the spherical top portion which is assembled with the centering pad with the loop-bending portion which is assembled with the first support together.

12. The assembling method of the miniature electroacoustic transducer according to claim 11, characterized in that,
the magnetic circuit system is assembled integrally before the step (c).

13. The assembling method of the miniature electroacoustic transducer according to claim 12, characterized in that,
a second support is arranged between the vibrating system and the magnetic circuit system; and the magnetic circuit system is assembled with the second support integrally before the step (c).

14. The assembling method of the miniature electroacoustic transducer according to claim 13, characterized in that,
the magnetic circuit system is of a dual magnetic circuit structure comprising an external concentrating flux plate and an external magnet, and an internal concentrating flux plate and an internal magnet which are sequentially assembled with the magnetic yoke respectively; and the magnetic circuit system is assembled by the following steps:
(a) assembling the internal concentrating flux plate, the internal magnet and the magnetic yoke sequentially, and fixedly assembling the external concentrating flux plate with the second support;
(b) assembling the external concentrating flux plate, the second support which have been assembled together, and the external magnet, with the internal concentrating flux plate, the internal magnet and the magnetic yoke, which have been assembled together, sequentially.
